(19) United States
(12) Patent Application Publication
(10) Pub. No.: US 2008/0174488 A1
(43) Pub. Date: Jul. 24, 2008

(54) Passive tracking antenna system

(76) Inventors: Eliahu Weinstein, San Diego, CA (US); Sam H. Eulmi, El Cajon, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/796,593

(22) Filed: Apr. 28, 2007

Related U.S. Application Data
(60) Provisional application No. 60/798,609, filed on May 8, 2006.

(51) Int. Cl. H01Q 3/00

(52) U.S. Cl. 342/377

(57) ABSTRACT

The present invention involves a tracking antenna system with no moving parts that extends the range of wireless mobile links 16 to 256 times the range of regular omni-directional whip antennas. The antenna system comprises an array of antenna segments arranged in a sphere or circle, or other suitable geometry. Each antenna segment includes one or more antennas connected and combined in parallel. Each antenna segment feeds a tuner and subsequent diversity electronics that optimizes both the transmission and reception in order to achieve the best possible range. The antenna system can be used from unmanned air, ground, and surface vehicles to mobile ground stations in motion, as well as between flying planes, moving vehicles, sailing boats, or any combination thereof. The system may be expanded further to many more levels of architecture as required. For example, this system may be expanded to a Level 2 diversity engine combination of any number and type of Level 1 antenna array units depending upon the diversity expansion required and the criteria for Level 2.

This patent application claims the benefit of earlier filed U.S. provisional patent application Ser. No. 60/798,609 filed on May 8, 2006.

### FIELD OF THE INVENTION

The present invention generally relates to the field of antenna systems. More specifically, this patent relates to passive tracking antenna systems. The term “passive” in this application specifically means that the system has no moving parts present.

### BACKGROUND OF THE INVENTION

Antenna systems use either an omni antenna to avoid tracking the source or use directional antennas with some means of following or tracking the source. The omni antenna has many disadvantages, for example low gain, which limits the operating range, susceptibility to jamming and interference, etc. Directional antennas on the other hand, require a global positioning system (GPS) to perform tracking or some other form of rotating direction finding equipment. Moving parts have their obvious disadvantages, for example, wear and tear of the moving parts and a maintenance schedule for replacing worn parts. Moreover, moving parts require significantly more power to drive their movement.

Therefore, there is a current need for a passive tracking antenna system for use between unmanned air, ground, and surface vehicles to mobile ground stations in motion, as well as between flying planes, moving vehicles, sailing boats, and combinations thereof, that extends the range of wireless mobile links, reduces the EMI signature of the links, limits the possibility of tracking and jamming of the links, and has direction finding capabilities without the need for GPS.

### SUMMARY OF THE INVENTION

The primary advantage of this invention is to provide a tracking antenna system that extends the range of wireless mobile links to 16 to 256 times the range of regular omni-directional whip antennas.

Another advantage of this invention is that it includes no moving parts, which facilitates its use in harsh environments, such as dusty and salty environments.

One advantage of this invention is to provide a tracking antenna system that reduces the EMI signature of the link.

A second advantage of this invention is to provide a tracking antenna system that limits the possibility of link hacking and jamming.

Another advantage of this invention is to provide a tracking antenna system that enables direction finding without the need for Global Positioning System.

Yet another advantage to this invention is to provide a tracking antenna system that can be used from unmanned air, ground and surface vehicles to mobile ground stations in motion, as well as between flying planes, moving vehicles, sailing boats, or any combination thereof.

These objects and further objects and features of the invention will be apparent to one skilled in the art from the disclosure of the present invention as set forth herein.

The present invention involves a tracking antenna system with no moving parts that extends the range of wireless mobile links 16 to 256 times the range of regular omni-directional whip antennas. The antenna system comprises an array of antenna segments arranged in a sphere or circle, or other suitable geometry. Each antenna segment includes one or more antennas connected and combined in parallel. Each antenna segment feeds a tuner and subsequent diversity electronics that optimizes both the transmission and reception in order to achieve the best possible range. The antenna system can be used from unmanned air, ground, and surface vehicles to mobile ground stations in motion, as well as between flying planes, moving vehicles, sailing boats, or any combination thereof.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principals of this invention.

FIG. 1 depicts a perspective view of the passive tracking antenna system, constructed in accordance with the present invention;

FIG. 2 depicts a top view of the passive tracking antenna system, constructed in accordance with the present invention;

FIG. 3 depicts a block diagram of the passive tracking antenna system, constructed in accordance with the present invention;

FIG. 4 depicts a block diagram of a transceiver tuner that can be contained within the passive tracking antenna system, constructed in accordance with the present invention; and

FIG. 5 depicts a block diagram of a two level expanded passive antenna tracking system that can be achieved through the use of two receiver/transceivers per diversity engine, constructed in accordance with the present invention.

FIG. 6 depicts a block diagram of a three level expanded passive antenna tracking system that can be achieved through the use of four receiver/transceivers per diversity engine, and a second diversity engine combined thereto for level three, constructed in accordance with the present invention.

For a fuller understanding of the nature and objects of the invention, reference should be had to the following detailed description taken in conjunction with the accompanying drawings which are incorporated in and form a part of this specification, illustrate embodiments of the invention and together with the description, serve to explain the principles of this invention.

### DETAILED DESCRIPTION OF THE PREFERRED EMBODIMENT

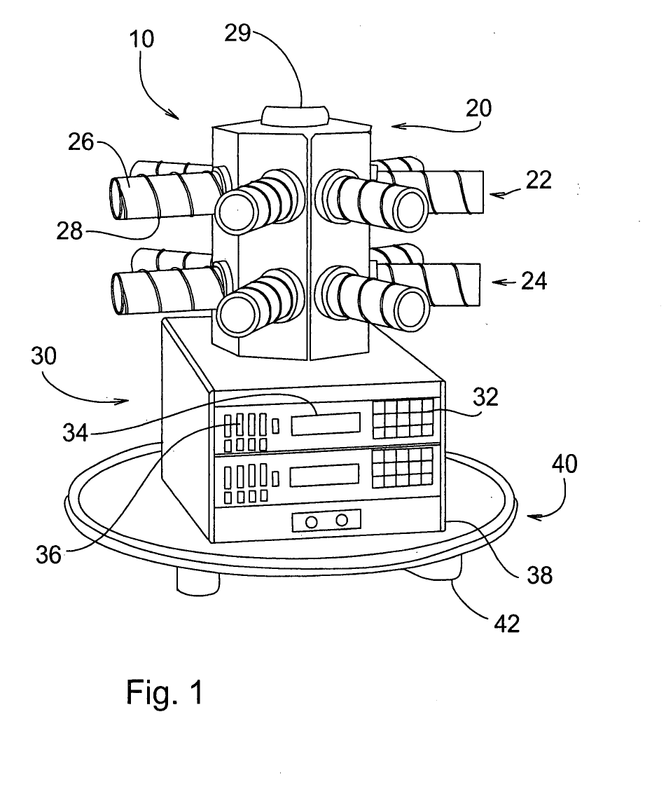

Referring now to the drawings, wherein similar parts are identified by like reference numerals, FIG. 1 shows a perspective view of the preferred embodiment of the passive tracking antenna system 10. Antenna system 10 includes an antenna array 20 attached to diversity electronics 30. Diversity electronics 30 is attached to a mounting interface 40 having base feet 42. Diversity electronics 30 includes a touch pad 32, a display 34, and mode switches 36 on the front surface thereof. Antenna system 10 may be inflatable to allow for easy transportation. Further, if array 20 is large enough, diversity electronics 30 can be positioned within the center portion of array 20, below upward pointing antenna member 29.

Array 20 includes antenna sectors 21 each having an upper antenna tube 22 and a lower antenna tube 24 to provide a hardware formed viewing angle and an increase in sector gain without making the entire antenna sector 21 too large. Antenna tubes 22 and 24 each contain a spiral antenna member 28. Array 20 can also include an upward pointing antenna member 29 on the top surface. Antenna members 28 and 29 are preferably high-gain directional antennas. Array 20 preferably includes seven antenna sectors 21, but can contain more or less antenna sectors 21 depending on size limitations. Array sectors 21 are preferably arranges in a spherical or circular pattern to cover the desired horizontal and vertical viewing angles of antenna system 10. However, array sectors 21 can also be arranged in different patterns to provide other viewing angles. Also, array 20 may be covered with a radome made of RF transparent material for protection against adverse environmental conditions, such as rain, condensation, dust, and other elements.

In a typical embodiment, antenna system 10 operates at 2.1 GHz-2.4 GHz with 14 circular polarized (CP) helical antenna members 28 forming a 360 degree circle in 7 antenna sectors 21, along with one CP patch upward pointing antenna member 29. This concept can be extended to any frequency from JF to mm wave. Each antenna sector 21 covers a viewing angle of 52 degrees (360/7) and has a gain of 14 dbi. This is a gain of 11 dbi over a 3 dbi whip antenna. In an alternate embodiment, an antenna system with 16 antenna members 28 allows an individual antenna gain of 24 dbi and an individual antenna viewing angle of 24 degrees (360/15). Each 6 dbi of antenna gain doubles a link's range. An alternate embodiment antenna system with 24 dbi antennas is equivalent to an increase in link range of 16:1 over a 0 dbi antenna. A system with two such tracking antennas communicating with each other is equivalent to an increase in link range of 128:1 over a link with two 3 dbi omni-directional whip antennas. Further, an antenna array of 32 antennas allows a gain of 27 dbi and a viewing angle of 12 degrees.

Antenna system 10 can also include several support circuits to control various elements of antenna system 10, including power supplies, means for remote tuning and controlling the antenna characteristics, and displays to show the signal direction, strength, and other status information. Antenna system 10 can further include other mechanical and hardware elements (not shown), such as housings, mounts, supports, and carrying cases.

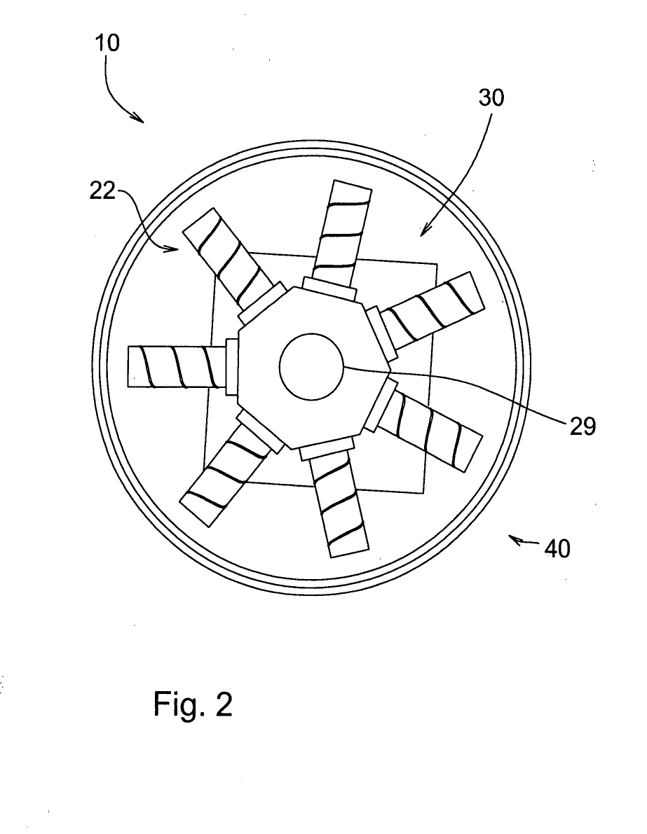

Referring now to FIG. 2, there is shown a top view of antenna system 10, illustrating the spatial relationship between upper antenna tubes 22, upward pointing antenna 29, diversity electronics 30, and mounting interface 40.

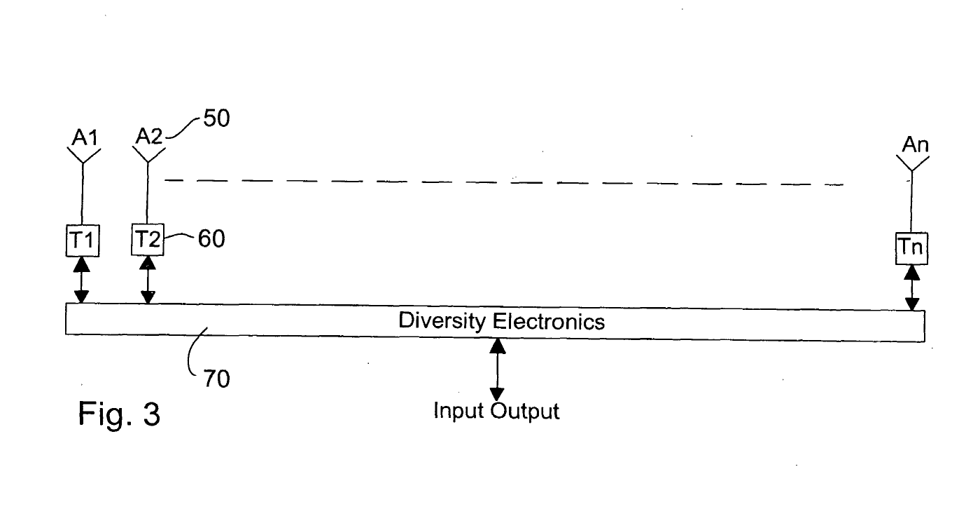

Referring now to FIG. 3, there is shown a block diagram of antenna system 10, illustrating the connection between various components. Antennas 50 are connected to tuners 60. Tuners 60 are connected to multiple diversity electronics 70. All tuners 60 operate on the same carrier frequency and transmit almost the same signal. A tuner 60 can be either a transmitter tuner, a receiver tuner, or a transceiver tuner. In a transmitter tuner, a transmitting tracking antenna system focuses all the transmitter power into a desired direction, reducing transmitted power by N (the number of antennas). It starts by allowing all tuners to transmit in all directions, with each tuner adding its tuner number. The receiver electronics determines which transmit antenna was the one that reached the receiver, communicating back to the transmitter (via a slow command & control link) which antennas to turn off and which antennas to leave on (in transmit mode).

In a receiver tuner, a receiving tracking antenna system has receive tuners only. It selects the antenna (or antenna combinations) by various criteria, like minimum bit-error-rate or the desire to ignore interfering signals from unwanted directions. Such an antenna system can have single tuners receiving single channels, single tuners receiving multiple channels in close spectral proximity, or multiple tuners connected to each antenna via splitters, with each tuner receiving different channels or multiple different channels. A transceiver tuner can perform the functions of both a transmitter tuner and a receiver tuner in one package, allowing for full two way communications between the tracking antenna system to a standard transceiver, or between two tracking antenna systems.

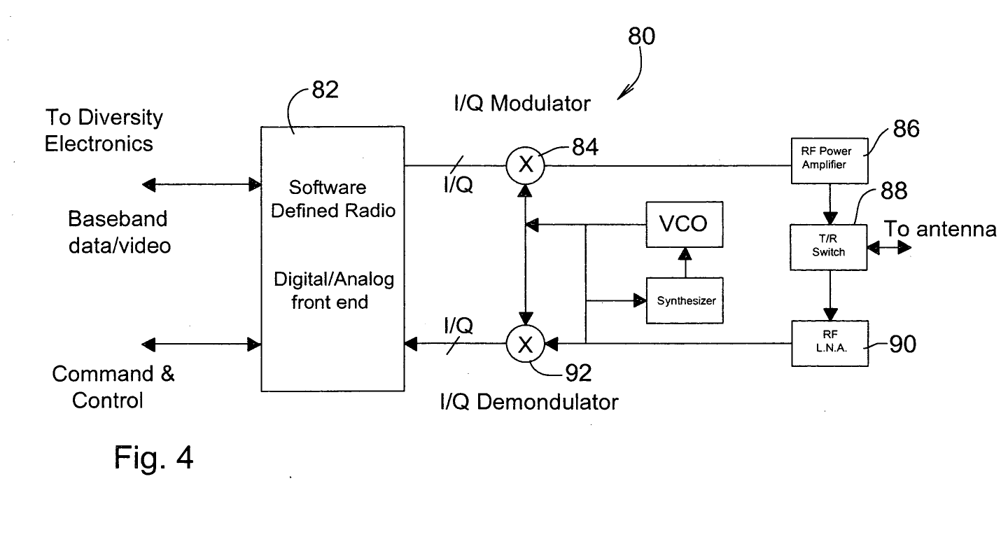

Referring now to FIG. 4, there is shown a block diagram of a transceiver tuner 80 that can be contained within antenna system 10. Baseband data/video input and command & control input enters tuner 80 from the diversity electronics (not shown). Both the baseband data/video and the command & control functions are bi-directional. The input is then passed through a software defined radio digital/analog front end 82, then through an I/Q modulator 84, then to a RF power amplifier 86, then to a transmit/receive switch 88, where, if in transmit mode, switch 88 relays the input to an antenna (not shown). If switch 88 is in receive mode, the output from the antenna is passed to an RF L.N.A. 90, then to an I/Q demodulator 92, then through the defined radio digital/analog front end 82, out to the diversity electronics via the baseband data/video output channel.

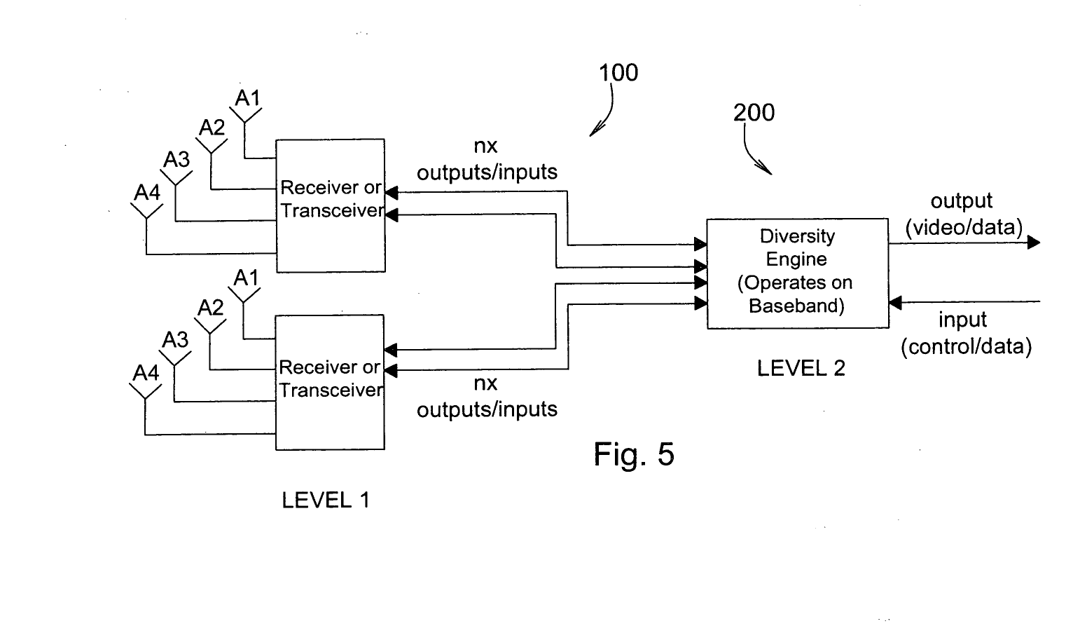

Referring now to FIG. 5, there is shown a block diagram of a two level passive tracking antenna system 100 that can be configured using two antenna arrays per diversity engine 200. As in previous systems disclosed, diversity electronics connect between the user interface and all of the antennas and tuners with two interfaces—a baseband data/video interface and a command & control interface. Diversity electronics includes both direction selection and finding circuitry (or software), exact location finding (when used in conjunction with a second tracking antenna system), and tuner control circuitry. Diversity electronics can be comprised of either a tuner or data packet selection logic based on signal quality or minimum Bit Error Rate (BER), or a Software Defined Radio (SDR) that selects the best antenna for transmission (one only) and receives on two or more antennas (for diversity) with electronic beam forming and jamming rejection logic. Such SDR can employ MIMO space-time equalizers and/or spectrum compression capabilities.

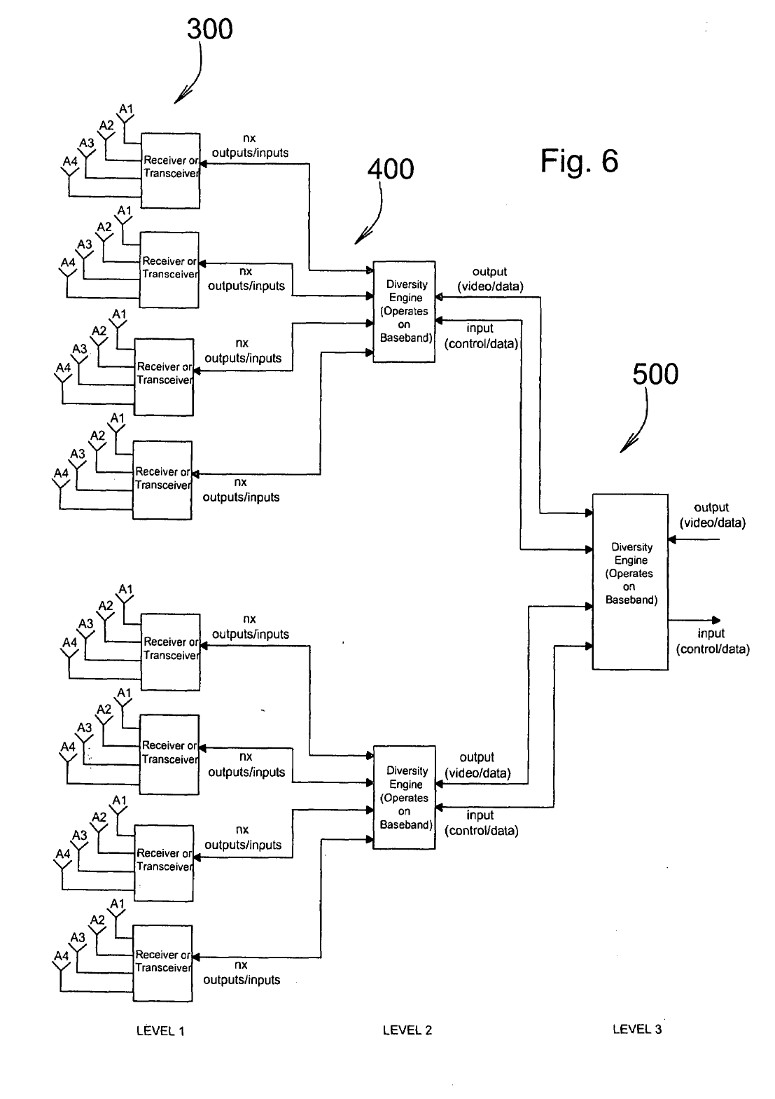

Depicted in FIG. 6 is another expanded passive tracking antenna system, in this example the system has three levels of architecture. Level 1 300 is in communication with Level 2 400 diversity engines, which in turn is in communication with a Level 3 500 diversity engine. Here there are four antenna arrays in Level 1 per each of two diversity engines in Level 2 in communication with a single diversity engine in Level 3. Each diversity engine as shown has four output/inputs. The system may be expanded further to many more levels of architecture as required. For example, this system may be expanded to a Level 2 combination of any number and type of Level 1 units depending upon the diversity expansion required and the criteria for Level 2.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The above description, together with the objects of the invention and the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Furthermore, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A passive tracking antenna system comprising:
a) a base portion;
b) an electronic user interface coupled to said base portion; and
c) an array of antenna segments connected in electrical communication with said electronic user interface, each antenna segment in said array of antenna segments connected and combined in parallel
whereby a user can use said electronic user interface to communicate with said array of antenna segments.

2. The passive antenna tracking system according to claim 1, wherein said base portion, said electronic user interface and said array of antenna segments further comprised no moving parts.

3. The passive antenna tracking system according to claim 1, wherein said array of antenna segments further includes an upper antenna tube and a lower antenna tube.

4. The passive antenna tracking system according to claim 3, wherein said antenna tubes each further comprise a spiral antenna member.

5. The passive antenna tracking system according to claim 1, wherein said electronic user interface further comprises diversity electronics which includes both direction selection and finding circuitry.

6. The passive antenna tracking system according to claim 5, wherein said direction selection and finding circuitry includes direction selection and finding software.

7. The passive antenna tracking system according to claim 5, wherein said diversity electronics is comprised of either a tuner or data packet selection logic based on signal quality or minimum Bit Error Rate (BER).

8. The passive antenna tracking system according to claim 6, wherein said diversity electronics is comprised of a Software Defined Radio (SDR) that selects the best single antenna for transmission and receives on two or more antennas with electronic beam forming and jamming rejection logic.

9. The passive antenna tracking system according to claim 1, wherein said SDR employs MIMO space-time equalizers and/or spectrum compression capabilities.

10. The passive antenna tracking system according to claim 1, wherein said array of antenna elements is scalable such that the passive antenna tracking system extends the range of wireless mobile links from 16 to 256 times.

11. A method for making a passive antenna tracking system comprising the steps of:
a) providing a base portion;
b) coupling an electronic user interface to said base portion; and
c) providing an array of antenna segments connected in electrical communication with said electronic user interface, each antenna segment in said array of antenna segments connected and combined in parallel;
whereby a user can use said electronic user interface to communicate with said array of antenna segments.

12. The method for making a passive antenna tracking system according to claim 11, wherein said step of providing a base portion, said electronic user interface and said array of antenna segments further comprises providing a base portion, said electronic user interface and said array of antenna segments having no moving parts.

13. The method for making a passive antenna tracking system according to claim 11, wherein said step of providing an array of antenna segments further includes providing an array of antenna segments having an upper antenna tube and a lower antenna tube.

14. The method for making a passive antenna tracking system according to claim 13, wherein said step of providing an array of antenna segments further includes providing an array of antenna segments having an upper antenna tube and a lower antenna tube antenna tubes each further comprise a spiral antenna member.

15. The method for making a passive antenna tracking system according to claim 11, wherein said step of coupling an electronic user interface further comprises the step of coupling an electronic user interface having diversity electronics wherein said diversity electronics includes both direction selection and finding circuitry.

16. The method for making a passive antenna tracking system according to claim 15, wherein said step of coupling diversity electronics having direction selection and finding circuitry further includes coupling diversity electronics having direction selection and finding software.

17. The method for making a passive antenna tracking system according to claim 15, wherein said coupled diversity electronics is comprised of either a tuner or data packet selection logic based on signal quality or minimum Bit Error Rate (BER).

18. The method for making a passive antenna tracking system according to claim 16, wherein said coupled diversity electronics is comprised of a Software Defined Radio (SDR) that selects the best single antenna for transmission and receives on two or more antennas with electronic beam forming and jamming rejection logic.

19. The method for making a passive antenna tracking system according to claim 11, wherein said SDR employs MIMO space-time equalizers and/or spectrum compression capabilities.

20. The method for making a passive antenna tracking system according to claim 11, further including the step of scaling up said array of antenna elements, such that the passive antenna tracking system extends the range of wireless mobile links from 16 to 256 times.
